(19) United States
(12) Patent Application Publication
(10) Pub. No.: US 2025/0156709 A1
(43) Pub. Date: May 15, 2025

(54) SYSTEM AND METHODS FOR TIME OR MEMORY BUDGET CUSTOMIZED DEEP LEARNING

(71) Applicant: GE Precision Healthcare LLC, Waukesha, WI (US)

(72) Inventors: Rahul Venkataramani, Bengaluru (IN); Prasad Sudhakara Murthy, Bengaluru (IN); Rachana Sathish, Bengaluru (IN); KS Shriram, Bengaluru (IN)

(21) Appl. No.: 18/942,209

(22) Filed: Nov. 8, 2024

(30) Foreign Application Priority Data
Nov. 9, 2023 (IN) 202341076543

(51) Int. Cl. G06N 3/08; G06N 3/045

(52) U.S. Cl. CPC G06N 3/08; G06N 3/045

(57) ABSTRACT

Methods and systems are provided for a customizable deep learning system. In one example, a system includes a processor and non-transitory memory storing instructions executable by the processor to receive a user selection of a time budget, enter an input to a deep learning system, the deep learning system including one or more deep learning models configured to generate a plurality of outputs based on the input, and wherein a number of outputs included in the plurality of outputs is based on the time budget, combine the plurality of outputs to form a final output, and output the final output for display on a display device, for downstream processing, and/or for storage in memory.

### RELATED APPLICATIONS

The present application claims priority to Indian Patent Application number 202341076543, entitled “SYSTEM AND METHODS FOR TIME OR MEMORY BUDGET CUSTOMIZED DEEP LEARNING,” and filed on Nov. 9, 2023, the entire contents of which is hereby incorporated by reference for all purposes.

### TECHNICAL FIELD

Embodiments of the subject matter disclosed herein relate to deep learning, and more particularly, to end-user customizable deep learning systems, such as for medical imaging applications.

### BACKGROUND

Medical imaging, such as ultrasound, may be used to non-invasively probe the internal structures of a body of a patient and produce a corresponding image. Medical images of the internal structures may be saved for later analysis by a clinician to aid in diagnosis and/or displayed on a display device in real time or near real time. In some examples, deep learning-based tools may be employed to identify internal structures, provide a suggested diagnosis, perform automated measurements, and the like.

### SUMMARY

In an embodiment, a system includes a processor and non-transitory memory storing instructions executable by the processor to receive a user selection of a time budget, enter an input to a deep learning system, the deep learning system including one or more deep learning models configured to generate a plurality of outputs based on the input, and wherein a number of outputs included in the plurality of outputs is based on the time budget, combine the plurality of outputs to form a final output, and output the final output for display on a display device, for downstream processing, and/or for storage in memory.

In another embodiment, a method includes receiving a plurality of outputs from a deep learning system based on an input image and a time budget set by a user during inference, combining the plurality of outputs to form a final output, and outputting the final output for display on a display device, for downstream processing, and/or for storage in memory.

In a further embodiment, a method includes receiving a plurality of outputs from a deep learning system based on an input image, a number of outputs included in the plurality of outputs based on a memory budget set by a user during training of one or more deep learning models of the deep learning system, combining the plurality of outputs to form a final output, and outputting the final output for display on a display device, for downstream processing, and/or for storage in memory.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 shows a block diagram of an embodiment of an ultrasound system;

FIG. 2 is a block diagram showing an example image processing system configured to store and execute a customizable deep learning system;

FIG. 3 schematically shows an example process for generating a final output from a customizable deep learning system based on an input time budget;

FIG. 4 is a flow chart illustrating a method for generating a final output from a customizable deep learning system based on an input time budget;

FIG. 5 schematically shows an example process for training a customizable deep learning system based on a memory budget;

FIG. 6 schematically shows an example process for generating a final output from the customizable deep learning system trained according to the process of FIG. 5;

FIG. 7 is a flow chart illustrating a method for training a customizable deep learning system based on a memory budget and generating a final output from the trained customizable deep learning system; and

FIGS. 8 and 9 show example segmentation masks produced by combining multiple outputs from the customizable deep learning systems disclosed herein.

### DETAILED DESCRIPTION

Medical images, such as ultrasound images, may be used to diagnose or rule out patient conditions in a non-invasive manner. To facilitate analysis of a patient condition, computerized tools such as deep learning models may be applied to medical images in order to provide automated or semi-automated measurements of anatomical features, identify or characterize tissue, or even suggest diagnoses of patient conditions. As an example, an anatomical region of interest (ROI), such as a kidney, a liver, a lesion, or a portion of a heart (e.g., a left ventricle), may be automatically identified using a deep learning segmentation network, also referred to as a segmentation model.

However, deep learning models often sacrifice performance for more rapid inference time or vice versa. In this way, deep learning models may be trained to generate more accurate outputs at the cost of longer inference times, or trained to generate outputs at relatively quick inference times (e.g., real-time or near real-time) at the cost of accuracy. While having a fixed performance-time relationship may be suitable for some deep learning implementations, certain users or scenarios may benefit from the ability to select a given inference time to enable rapid generation of deep learning output in some scenarios where speed is preferred over accuracy and enable slower generation of deep learning output in other scenarios where accuracy is preferred over speed.

Thus, according to embodiments disclosed herein, a customizable deep learning system may be trained to generate a plurality of outputs from a single input, such as an input medical image, wherein the number of outputs generated by the customizable deep learning system may be based on a prompt, such as a user- or system-defined time budget. For example, when the time budget is relatively high, the deep learning system may generate a first, higher number of outputs and when the time budget is relatively low, the deep learning system may generate a second, lower number of outputs. The outputs may be combined to form a final output that is displayed and/or saved in memory. By generating the first, higher number of outputs, the accuracy of the final output may be increased. In contrast, by generating the second, lower number of outputs, the accuracy of the final output may be decreased but the speed at which the final output is generated may be increased (e.g., the final output may be generated in a shorter amount of time). Further, by giving the user the option of a higher accuracy, longer inference time output or a lower accuracy, shorter inference time output, unnecessary processing actions used to generate the higher accuracy output may be avoided during conditions where the higher accuracy is not demanded, thereby increasing the processing efficiency of the computing device executing the deep learning system.

In some examples, the customizable deep learning system may include a single neural network that can generate a plurality of different outputs from the same input by performing a plurality of iterations/forward passes of the input. In some examples, the input may be adjusted/augmented in a different manner each iteration (referred to as test-time augmentation). In other examples, the neural network parameters may be adjusted/perturbed in a different manner with each iteration. For example, Monte Carlo (MC) dropout may be performed, such that one or more neurons of the network may be randomly dropped (while the remaining neurons are active) each iteration/forward pass of the input. In still further examples, the input may be input to the neural network along with different support sets of input-label pairs that define the task to be performed (e.g., segmentation task) for each iteration. The number of iterations/forward passes may be selected based on the time budget, such that more iterations are performed (and hence more outputs are produced) when the time budget is higher and fewer iterations are performed (and hence fewer outputs are produced) when the time budget is lower.

In other examples, the customizable deep learning system may include multiple deep learning models, such as multiple neural networks. The multiple deep learning models may be trained with different training datasets and/or the multiple deep learning models may include different architecture. The input may be input into a selected set of the multiple deep learning models to produce the plurality of outputs, where the number of models in the selected set is based on the time budget (e.g., an increasing number of models may be selected as the time budge increases). However, the multiple deep learning models may demand more memory and thus may be less desirable in situations where memory is limited.

As a specific example, the customizable deep learning system may be a neural network trained to segment a kidney in ultrasound images. An ultrasound image may be entered as input to the deep learning system along with a user-selected time budget. The number of iterations/forward passes of the image through the deep learning system/neural network may be selected based on the time budget, and the segmentation masks generated by the multiple iterations of the neural network may be combined to form the final segmentation.

In some examples, the multiple outputs may be combined into the final output via averaging, voting, or another suitable method. However, simple averaging may be susceptible to skewing by outlier outputs, thereby making the final output less accurate than possible. This may particularly be the case for segmentation models, which may occasionally generate outlier outputs where the shape of the segmentation does not match the expected shape of the relevant anatomy. Thus, rather than combining the outputs via averaging, a specialized fusion algorithm, referred to as simultaneous truth and performance level estimation (STAPLE), may be utilized that estimates a hidden “true” output (e.g., segmentation) based on the plurality of outputs using an expectation-maximization (EM) algorithm.

It is to be appreciated that the customizable deep learning system disclosed herein (customized based on a time budget and/or memory budget) may be applicable with other types of inputs and tasks. For example, medical or non-medical images may be processed via the customizable deep learning system to identify and/or segment objects of interest, remove noise or artifacts, or the like. In still further examples, non-image inputs may be processed by the customizable deep learning system, such as text (e.g., to perform a suitable task, such as word recognition, language translation, etc.) or raw data (e.g., projection data from a computed tomography (CT) system may be processed by the customizable deep learning system to generate images from the projection data). Medical images and segmentation to identify anatomical features of interest are presented herein as merely examples of the input and task the customizable deep learning system is configured to perform, and others are possible without departing from the scope of this disclosure.

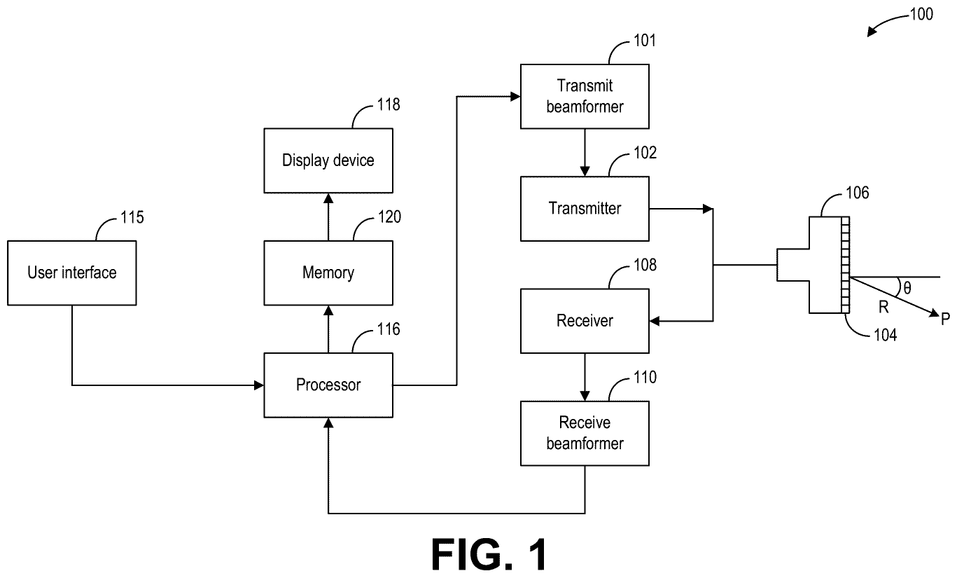

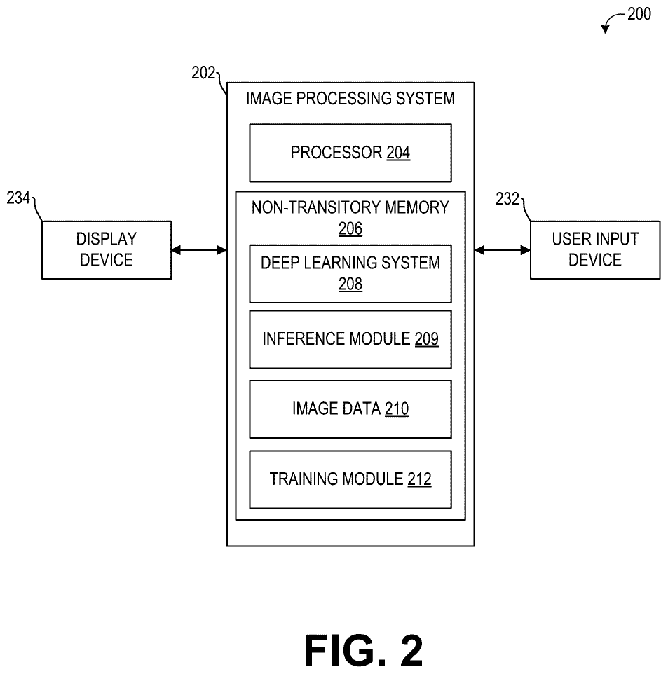

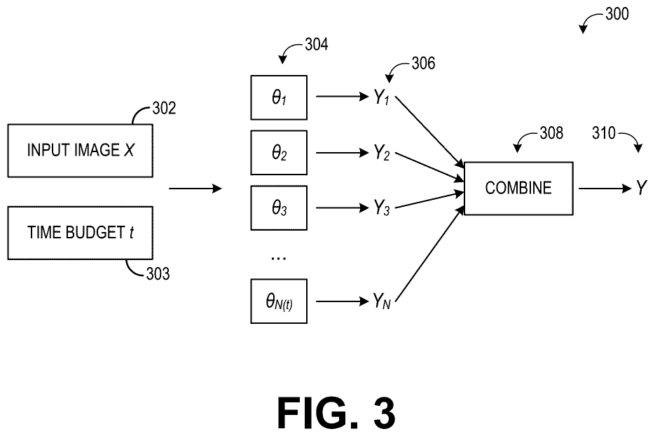

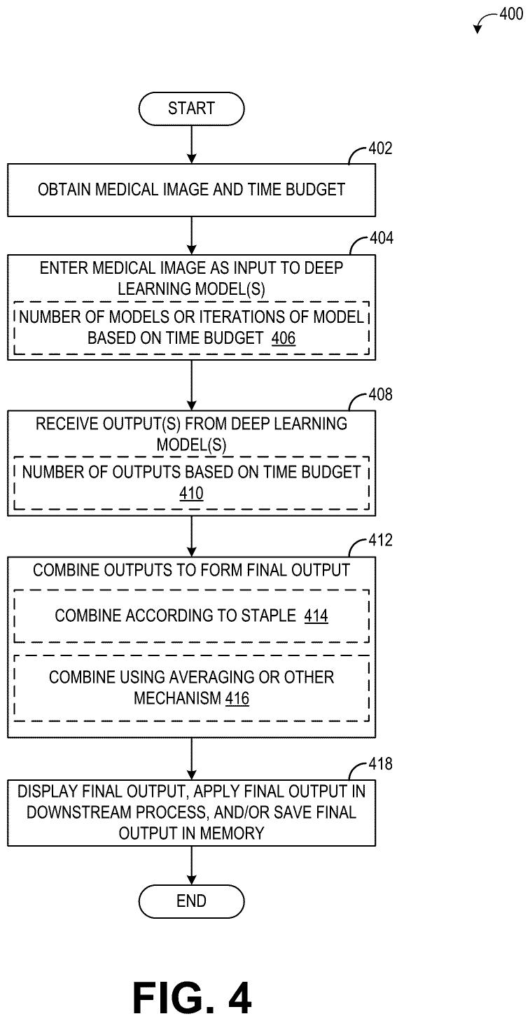

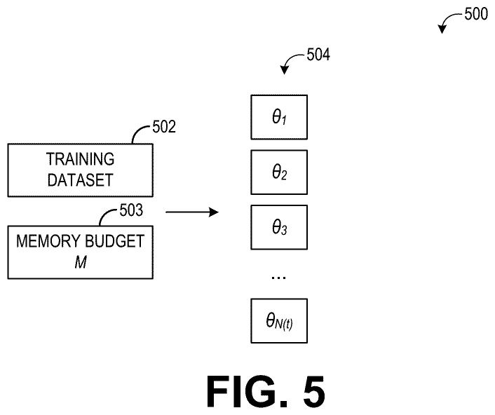

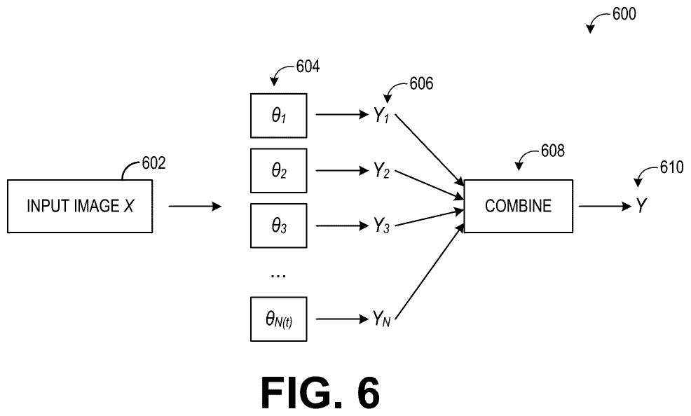

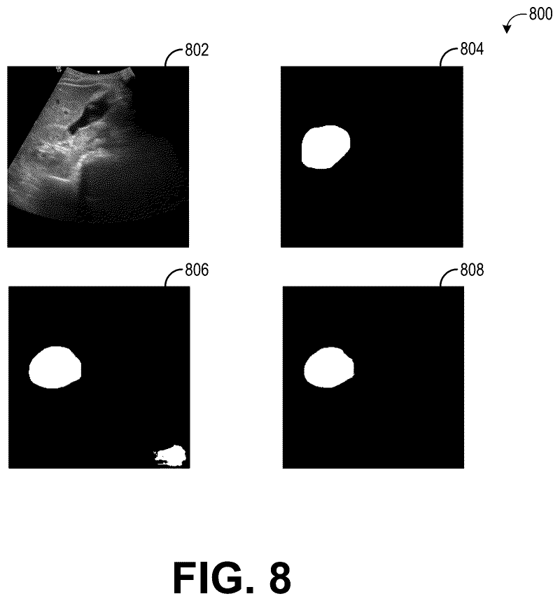

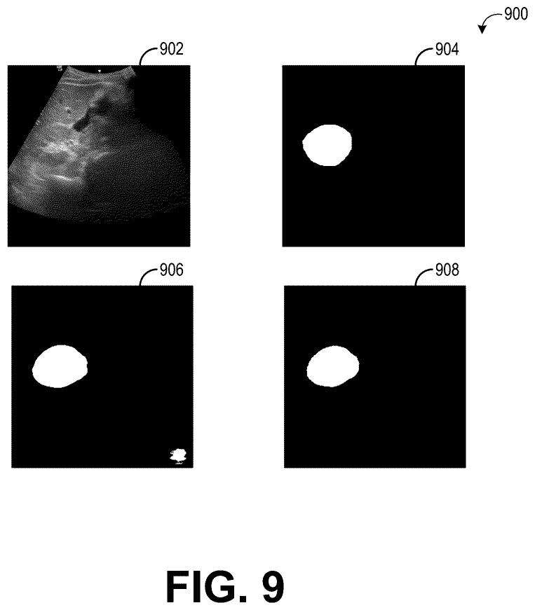

An example ultrasound system including an ultrasound probe, a display device, and an imaging processing system are shown in FIG. 1. Via the ultrasound probe, ultrasound data may be acquired and processed into ultrasound images that may be displayed on the display device. The ultrasound images may be processed by an image processing system, such as by the image processing system of FIG. 2, to perform a task with the ultrasound images using a deep learning system, such as segment an anatomical ROI. FIG. 3 shows an example deep learning system that may be used to generate a plurality of outputs that are combined into a final output, where the number of outputs in the plurality of outputs is a function of a time budget set by a user. FIG. 4 shows an example method for generating a final output using a deep learning system and time budget. FIGS. 5 and 6 show another example deep learning system that may be trained according to a memory budget to generate a plurality of outputs that can be combined to form a final output. FIGS. 8 and 9 show example segmentation masks that may be generated using the example deep learning systems disclosed herein.

The deep learning systems disclosed herein may be applied to medical images in order to perform a desired task, such as segmentation of a specified anatomical feature. An example ultrasound imaging system usable to generate medical images that can be input to the deep learning systems as disclosed herein is shown in FIG. 1. However, it is to be appreciated that an ultrasound imaging system is presented herein as an example medical imaging system and that the deep learning systems may be implemented with other medical images without departing from the scope of this disclosure, such as CT images, magnetic resonance (MR) images, x-ray images, visible light images, and the like.

Referring to FIG. 1, a schematic diagram of an ultrasound imaging system 100 in accordance with an embodiment of the disclosure is shown. The ultrasound imaging system 100 includes a transmit beamformer 101 and a transmitter 102 that drives elements (e.g., transducer elements) 104 within a transducer array, herein referred to as probe 106, to emit pulsed ultrasonic signals (referred to herein as transmit pulses) into a body (not shown). According to an embodiment, the probe 106 may be a one-dimensional transducer array probe. However, in some embodiments, the probe 106 may be a two-dimensional matrix transducer array probe. As explained further below, the transducer elements 104 may be comprised of a piezoelectric material. When a voltage is applied to a piezoelectric crystal, the crystal physically expands and contracts, emitting an ultrasonic wave. In this way, transducer elements 104 may convert electronic transmit signals into acoustic transmit beams.

After the elements 104 of the probe 106 emit pulsed ultrasonic signals into a body (of a patient), the pulsed ultrasonic signals reflect from structures within an interior of the body, like blood cells or muscular tissue, to produce echoes that return to the elements 104. The echoes are converted into electrical signals, or ultrasound data, by the elements 104 and the electrical signals are received by a receiver 108. The electrical signals representing the received echoes are passed through a receive beamformer 110 that outputs ultrasound data.

The echo signals produced by transmit operation reflect from structures located at successive ranges along the transmitted ultrasonic beam. The echo signals are sensed separately by each transducer element and a sample of the echo signal magnitude at a particular point in time represents the amount of reflection occurring at a specific range. Due to the differences in the propagation paths between a reflecting point P and each element, however, these echo signals are not detected simultaneously. Receiver 108 amplifies the separate echo signals, imparts a calculated receive time delay to each, and sums them to provide a single echo signal which approximately indicates the total ultrasonic energy reflected from point P located at range R along the ultrasonic beam oriented at the angle θ.

The time delay of each receive channel continuously changes during reception of the echo to provide dynamic focusing of the received beam at the range R from which the echo signal is assumed to emanate based on an assumed sound speed for the medium.

Under direction of processor 116, the receiver 108 provides time delays during the scan such that steering of receiver 108 tracks the direction θ of the beam steered by the transmitter and samples the echo signals at a succession of ranges R so as to provide the time delays and phase shifts to dynamically focus at points P along the beam. Thus, each emission of an ultrasonic pulse waveform results in acquisition of a series of data points which represent the amount of reflected sound from a corresponding series of points P located along the ultrasonic beam.

According to some embodiments, the probe 106 may contain electronic circuitry to do all or part of the transmit beamforming and/or the receive beamforming. For example, all or part of the transmit beamformer 101, the transmitter 102, the receiver 108, and the receive beamformer 110 may be situated within the probe 106. The terms “scan” or “scanning” may also be used in this disclosure to refer to acquiring data through the process of transmitting and receiving ultrasonic signals. The term “data” may be used in this disclosure to refer to either one or more datasets acquired with an ultrasound imaging system. A user interface 115 may be used to control operation of the ultrasound imaging system 100, including to control the input of patient data (e.g., patient medical history), to change a scanning or display parameter, to initiate a probe repolarization sequence, and the like. The user interface 115 may include one or more of the following: a rotary element, a mouse, a keyboard, a trackball, hard keys linked to specific actions, soft keys that may be configured to control different functions, and a graphical user interface displayed on a display device 118.

The ultrasound imaging system 100 also includes a processor 116 to control the transmit beamformer 101, the transmitter 102, the receiver 108, and the receive beamformer 110. The processor 116 is in electronic communication (e.g., communicatively connected) with the probe 106. For purposes of this disclosure, the term “electronic communication” may be defined to include both wired and wireless communications. The processor 116 may control the probe 106 to acquire data according to instructions stored on a memory of the processor, and/or memory 120. The processor 116 controls which of the elements 104 are active and the shape of a beam emitted from the probe 106. The processor 116 is also in electronic communication with the display device 118, and the processor 116 may process the data (e.g., ultrasound data) into images for display on the display device 118. The processor 116 may include a central processor (CPU), according to an embodiment. According to other embodiments, the processor 116 may include other electronic components capable of carrying out processing functions, such as a digital signal processor, a field-programmable gate array (FPGA), or a graphic board. According to other embodiments, the processor 116 may include multiple electronic components capable of carrying out processing functions. For example, the processor 116 may include two or more electronic components selected from a list of electronic components including: a central processor, a digital signal processor, a field-programmable gate array, and a graphic board. According to another embodiment, the processor 116 may also include a complex demodulator (not shown) that demodulates the real RF (radio-frequency) data and generates complex data. In another embodiment, the demodulation can be carried out earlier in the processing chain. The processor 116 is adapted to perform one or more processing operations according to a plurality of selectable ultrasound modalities on the data. In one example, the data may be processed in real-time during a scanning session as the echo signals are received by receiver 108 and transmitted to processor 116. For the purposes of this disclosure, the term “real-time” is defined to include a procedure that is performed without any intentional delay. For example, an embodiment may acquire images at a real-time rate of 7-20 frames/sec. The ultrasound imaging system 100 may acquire 2D data of one or more planes at a significantly faster rate. However, it should be understood that the real-time frame-rate may be dependent on the length of time that it takes to acquire each frame of data for display. Accordingly, when acquiring a relatively large amount of data, the real-time frame-rate may be slower. Thus, some embodiments may have real-time frame-rates that are considerably faster than 20 frames/sec while other embodiments may have real-time frame-rates slower than 7 frames/sec. The data may be stored temporarily in a buffer (not shown) during a scanning session and processed in less than real-time in a live or off-line operation. Some embodiments of the invention may include multiple processors (not shown) to handle the processing tasks that are handled by processor 116 according to the exemplary embodiment described hereinabove. For example, a first processor may be utilized to demodulate and decimate the RF signal while a second processor may be used to further process the data, for example by augmenting the data as described further herein, prior to displaying an image. It should be appreciated that other embodiments may use a different arrangement of processors.

The ultrasound imaging system 100 may continuously acquire data at a frame-rate of, for example, 10 Hz to 30 Hz (e.g., 10 to 30 frames per second). Images generated from the data may be refreshed at a similar frame-rate on display device 118. Other embodiments may acquire and display data at different rates. For example, some embodiments may acquire data at a frame-rate of less than 10 Hz or greater than 30 Hz depending on the size of the frame and the intended application. A memory 120 is included for storing processed frames of acquired data. In an exemplary embodiment, the memory 120 is of sufficient capacity to store at least several seconds' worth of frames of ultrasound data. The frames of data are stored in a manner to facilitate retrieval thereof according to its order or time of acquisition. The memory 120 may comprise any known data storage medium.

In various embodiments of the present invention, data may be processed in different mode-related modules by the processor 116 (e.g., B-mode, Color Doppler, M-mode, Color M-mode, spectral Doppler, Elastography, TVI, strain, strain rate, and the like) to form 2D or 3D data. For example, one or more modules may generate B-mode, color Doppler, M-mode, color M-mode, spectral Doppler, Elastography, TVI, strain, strain rate, and combinations thereof, and the like. As one example, the one or more modules may process color Doppler data, which may include traditional color flow Doppler, power Doppler, HD flow, and the like. The image lines and/or frames are stored in memory and may include timing information indicating a time at which the image lines and/or frames were stored in memory. The modules may include, for example, a scan conversion module to perform scan conversion operations to convert the acquired images from beam space coordinates to display space coordinates. A video processor module may be provided that reads the acquired images from a memory and displays an image in real time while a procedure (e.g., ultrasound imaging) is being performed on a patient. The video processor module may include a separate image memory, and the ultrasound images may be written to the image memory in order to be read and displayed by display device 118.

In various embodiments of the present disclosure, one or more components of ultrasound imaging system 100 may be included in a portable, handheld ultrasound imaging device. For example, display device 118 and user interface 115 may be integrated into an exterior surface of the handheld ultrasound imaging device, which may further contain processor 116 and memory 120. Probe 106 may comprise a handheld probe in electronic communication with the handheld ultrasound imaging device to collect raw ultrasound data. Transmit beamformer 101, transmitter 102, receiver 108, and receive beamformer 110 may be included in the same or different portions of the ultrasound imaging system 100. For example, transmit beamformer 101, transmitter 102, receiver 108, and receive beamformer 110 may be included in the handheld ultrasound imaging device, the probe, and combinations thereof.

After performing a two-dimensional ultrasound scan, a block of data comprising scan lines and their samples is generated. After back-end filters are applied, a process known as scan conversion is performed to transform the two-dimensional data block into a displayable bitmap image with additional scan information such as depths, angles of each scan line, and so on. During scan conversion, an interpolation technique is applied to fill missing holes (i.e., pixels) in the resulting image. These missing pixels occur because each element of the two-dimensional block should typically cover many pixels in the resulting image. For example, in current ultrasound imaging systems, a bicubic interpolation is applied which leverages neighboring elements of the two-dimensional block. As a result, if the two-dimensional block is relatively small in comparison to the size of the bitmap image, the scan-converted image will include areas of less than optimal or low resolution, especially for areas of greater depth.

Referring to FIG. 2, an image processing system 202 is shown, in accordance with an embodiment of the disclosure. In some embodiments, image processing system 202 is incorporated into the ultrasound imaging system 100. For example, the image processing system 202 may be provided in the ultrasound imaging system 100 as the processor 116 and memory 120. In some embodiments, at least a portion of image processing system 202 is included in a device (e.g., edge device, server, etc.) communicably coupled to the ultrasound imaging system via wired and/or wireless connections. In some embodiments, at least a portion of image processing system 202 is included in a separate device (e.g., a workstation), which can receive images from the ultrasound imaging system or from a storage device which stores the images/data generated by the ultrasound imaging system. Image processing system 202 may be operably/communicatively coupled to a user input device 232 and a display device 234. In one example, the user input device 232 may comprise the user interface 115 of the ultrasound imaging system 100, while the display device 234 may comprise the display device 118 of the ultrasound imaging system 100.

Image processing system 202 includes a processor 204 configured to execute machine readable instructions stored in non-transitory memory 206. Processor 204 may be single core or multi-core, and the programs executed thereon may be configured for parallel or distributed processing. In some embodiments, the processor 204 may optionally include individual components that are distributed throughout two or more devices, which may be remotely located and/or configured for coordinated processing. In some embodiments, one or more aspects of the processor 204 may be virtualized and executed by remotely-accessible networked computing devices configured in a cloud computing configuration.

Non-transitory memory 206 may store a deep learning system 208, an inference module 209, image data 210, and optionally a training module 212. Deep learning system 208 may include one or more machine learning models, such as deep learning networks, comprising a plurality of weights and biases, activation functions, loss functions, gradient descent algorithms, and instructions for implementing the one or more deep neural networks to process input images in order to perform a task, such as segmenting a region of interest. Deep learning system 208 may include trained and/or untrained neural networks and may further include parameters (e.g., weights and biases) associated with one or more neural network models stored therein. As will be explained herein, inference module 209 may be configured to execute the deep learning system on a selected image and combine the plurality of outputs generated by the deep learning system in order to generate a final output that may be displayed on display device 234, stored in memory 206, and/or sent to a separate device for long-term storage.

Image data 210 may include ultrasound images captured by the ultrasound imaging system 100 of FIG. 1 or another ultrasound imaging system and/or other types of medical images (e.g., CT images, MR images, x-ray images, etc.). The image data 210 may include 2D images and/or 3D volumetric data, from which 2D images/slices may be generated. When the image data 210 includes ultrasound images, the ultrasound images may include B-mode images, Doppler images, color Doppler images, M-mode images, etc., and/or combinations thereof.

Non-transitory memory 206 may further include training module 212, which comprises instructions for training one or more of the machine learning models stored in deep learning system 208. In some embodiments, the training module 212 is not disposed at the image processing system 202. The deep learning system 208 thus includes trained and validated network(s). In some embodiments, such as when training module 212 is included on image processing system 202, image data 210 may store images and ground truth output in an ordered format, such that each image is associated with one or more corresponding ground truth outputs. However, in examples where training module 212 is not disposed at the image processing system 202, the images/ground truth output usable for training the deep learning system 208 may be stored elsewhere.

In some embodiments, the non-transitory memory 206 may include components included in two or more devices, which may be remotely located and/or configured for coordinated processing. In some embodiments, one or more aspects of the non-transitory memory 206 may include remotely-accessible networked storage devices configured in a cloud computing configuration.

User input device 232 may comprise one or more of a touchscreen, a keyboard, a mouse, a trackpad, a motion sensing camera, or other device configured to enable a user to interact with and manipulate data within image processing system 202. In one example, user input device 232 may enable a user to make a selection of an image to be entered as input to deep learning system 208 and/or make a selection of a time budget for customizing the output of the deep learning system 208.

Display device 234 may include one or more display devices utilizing virtually any type of technology. In some embodiments, display device 234 may comprise a computer monitor, and may display ultrasound images. Display device 234 may be combined with processor 204, non-transitory memory 206, and/or user input device 232 in a shared enclosure, or may be peripheral display devices and may comprise a monitor, touchscreen, projector, or other display device known in the art, which may enable a user to view ultrasound images produced by an ultrasound imaging system, and/or interact with various data stored in non-transitory memory 206.

It should be understood that image processing system 202 shown in FIG. 2 is for illustration, not for limitation. Another appropriate image processing system may include more, fewer, or different components.

Thus, the image processing system 202 may be configured to take a medical image, such as an ultrasound image, and input the medical image to the deep learning system 208. The deep learning system 208 may generate a plurality of different but related outputs from the input medical image. For example, the deep learning system 208 may generate a plurality of segmentation masks of an anatomical feature (e.g., a kidney) in the medical image. The plurality of outputs may be combined via the inference module 209 to form the final output using averaging, voting, or a STAPLE algorithm. The STAPLE algorithm applies a probabilistic method to assign non-equal weights to different outputs based on an intelligent estimation of the performance or accuracy of each individual output and combines the outputs according to the non-equal weights. By generating multiple outputs and combining the outputs using STAPLE or another fusion algorithm (e.g., averaging), the accuracy of the final output may be increased relative to more conventional approaches where only one output is produced from one deep learning model.

However, generating multiple outputs using the deep learning system 208 disclosed herein may be time-consuming and/or the deep learning system 208 disclosed herein may demand a relatively large amount of memory. Thus, in some examples, the number of outputs generated by the deep learning system 208 may be a function of a prompt that dictates a time budget for inference (e.g., from a user). In this way, fewer outputs may be generated when the user requests a lower time budget, which may result in the final output being generated more rapidly than when all possible outputs are generated. While fewer outputs may lower accuracy, the deep learning system 208 may be constrained so that a minimum number of outputs are produced to facilitate combination of the outputs via a selection fusion algorithm (e.g., STAPLE), which may ensure that a minimum accuracy is achieved. Additional details about generating output with a deep learning system based on a time budget are provided below with respect to FIGS. 3 and 4.

In other examples, the number of outputs generated by the deep learning system 208 may be a function of a memory budget set during training of the deep learning system 208. For example, during training, a user may set a memory budget that defines a maximum memory utilized by the deep learning system once deployed. The deep learning model(s) of the deep learning system may be trained to produce the desired final output utilizing the memory dictated by the memory budget, which may result in a set number of outputs being generated by the deep learning system each time the deep learning system is deployed. Additional details about training and deploying a deep learning system based on a memory budget are provided below with respect to FIGS. 5-7.

FIG. 3 schematically shows an example process 300 for producing a final output from an input and a time budget using a deep learning system. The process 300 may be implemented by image processing system 202 using the deep learning system 208 and inference module 209, at least in some examples. The process 300 may include identification/reception of an input image 302 and a time budget 303. The input image may be a medical image, such as an ultrasound image of a patient generated with the ultrasound imaging system 100 of FIG. 1. The time budget 303 may be selected/set by a user, such as an operator of the ultrasound imaging system or another clinician, or based on a scan protocol, an exam protocol, or the like. For example, the medical image may be displayed on a display device via a graphical user interface (GUI) and the GUI may include a time budget user interface element that may be selected/adjusted by the user to select/set the time budget. The time budget may be expressed as a number on a predefined scale, such as 0-10, with 0 representing the shortest time budget possible (least amount of compute/inference time) and the time budget increasing from 0 to the end of the scale. In some examples, the time budget may be expressed as a number of seconds that the user is willing to wait, such as 0 (e.g., real-time) and on up to a maximum time (e.g., 100 seconds or more). In some examples, the time budget may be expressed as a percentage, with 0% representing a minimum time in which the output can be generated and 100% representing a maximum time for producing the output. In further examples, the time budget may be expressed in relative terms, such as “fast,” “medium,” and “slow.” In still further examples, the user may be presented with accuracy metrics rather than a time budget, such as “high accuracy,” “medium accuracy,” and “low accuracy” and the time budget may be calculated based on the specified accuracy (e.g., a relatively low time budget for lower accuracy and a relatively high time budget for higher accuracy).

The deep learning system may include one or more deep learning models that may be iterated one or more times to produce a plurality of outputs. The number of models applied to produce the plurality of outputs, or the number of times a model is iterated to produce the plurality of outputs, may be selected based on the time budget 303, denoted t in FIG. 3. As shown in FIG. 3, the input image 302 (denoted X in FIG. 3) may be input to a plurality of model instances 304, represented in FIG. 3 as θ₁, θ₂, θ₃, and on up to θ_{N(t)} where the number of model instances in the plurality of model instances 304 is a function of the time budget (t). The plurality of model instances 304 may include all or a subset of a total possible number of model instances, depending on the size of the time budget (e.g., the plurality may include all possible model instances when the time budget is the maximum time budget, and may include fewer than all possible model instances when the time budget is less than the maximum).

In some examples, the plurality of model instances 304 may include a plurality of different models, such that θ₁ represents a first deep learning model, θ₂ represents a second deep learning model, θ₃ represents a third deep learning model, etc. In such an example, the different deep learning models may be models with the same architecture (e.g., convolutional neural networks (CNNs) with UNet architecture) but trained with different training datasets; models with different architectures (e.g., a fully convolutional network, an autoencoder network, a UNet, etc.) trained with the same training dataset; or a combination of both.

In other examples, the plurality of model instances 304 may include different iterations of the same deep learning model, such that θ₁ represents a first iteration of the deep learning model, θ₂ represents a second iteration of the deep learning model, θ₃ represents a third iteration of the deep learning model, etc. In such an example, each iteration may be different in some regard that results in a different output. For example, when test-time augmentation is applied, the input image 302 may be augmented in a different manner at each iteration. The input image 302 may be augmented by performing geometric and/or appearance transformations on the input image, such as rotating the input image by a different angle each iteration, adjusting the intensity, contrast, brightness, etc., of the input image each iteration, scaling the input image a different amount each iteration, adjusting histogram stretching/mapping each iteration, etc. In this manner, θ₁ may represent a first iteration of the deep learning model where the input image 302 is rotated by a first amount (e.g., 15°), θ₂ may represent a second iteration of the deep learning model where the intensity of the input image 302 is adjusted by a first amount, θ₃ may represent a third iteration of the deep learning model where the input image 302 is scaled by a first amount, etc. As another example, when MC dropout is applied, the same (unaugmented) input image 302 may be entered as input for each model instance, and one or more neurons of the deep learning model may be dropped each iteration, such that θ₁ may represent a first iteration of the deep learning model where a first neuron of the deep learning model is dropped, θ₂ may represent a second iteration of the deep learning model where a second neuron is dropped, θ₃ may represent a third iteration of the deep learning model where a third neuron is dropped, etc. Still other modifications of the input image and/or model may be performed at each iteration to result in the plurality of model instances 304, such as changing the weights of the deep learning model each iteration, changing the support set images entered along with the input image (when the deep learning model is a UniverSeg model) each iteration, etc. When test-time augmentation or MC dropout is applied to generate the plurality of outputs, the deep learning model may have any desired architecture (e.g., UNet) and may be trained using a desired training regime (e.g., supervised learning), dependent on the task that the deep learning model is to perform.

Once the input image 302 has been entered into the deep learning model(s) for the plurality of model instances 304, a plurality of outputs 306 is generated. Each instance/iteration of the deep learning model(s) may generate a respective output, such as Y₁ generated by instance θ₁, Y₂ generated by instance θ₂, Y₃ generated by instance θ₃, and on up to Y_{N} generated by instance θ_{N(t)}. Each output of the plurality of outputs 306 may be similar but not identical. For example, when the deep learning system is trained to segment a kidney in ultrasound images and the input image 302 is an ultrasound image of a patient, each output of the plurality of outputs 306 may include a segmentation mask indicating the location, size, and shape of the kidney in the input image. However, because each output is generated by a different model instance, each segmentation mask may be different in at least some respects than the other segmentation masks of the plurality of outputs 306. The plurality of outputs 306 may therefore be combined at 308 to form a final output 310 (denoted Y in FIG. 3). In the example shown in FIG. 3, the outputs may be combined using the STAPLE algorithm, as explained above, which may estimate the true, hidden output based on the distribution of the outputs of the plurality of outputs 306. In some examples, other mechanisms may be applied to combine the outputs, such as a non-weighted averaging of the outputs, particularly when the time budget is relatively short and the plurality of model instances 304 includes a small number of model instances and hence the plurality of outputs 306 includes a small number of outputs (e.g., two or three outputs). However, when sufficient outputs are generated to combine the outputs via the STAPLE algorithm, the accuracy of the final output 310 may be increased relative to simple averaging, when compared to a ground truth output (e.g., generated via one or more experts, generated when imaging a phantom, or when the output is otherwise known), which is explained in more detail below.

Thus, the process 300 may be applied to generate an output Y (e.g., a segmentation mask) based on an input X (e.g., an image) and a time budget t. In doing so, the output may be generated within the time budget, which may vary based on the user and/or the circumstances surrounding the generation of the output. For example, during a scanning session where a patient is being actively imaged with an imaging system (e.g., the ultrasound imaging system 100 of FIG. 1), an operator of the imaging system may desire to view an identification of a particular anatomical feature in a selected image of the patient in order to determine if further images should be acquired or to ensure that the particular anatomical feature is actually being imaged (which may be particularly helpful for novice operators). In such circumstances, the accuracy of the segmentation performed on the selected image to identify the anatomical feature may not be valued as highly as other circumstances, e.g., delineating the exact borders of the anatomical feature may not be demanded, but the speed at which the segmentation is performed may be highly valued. In this case, the user may select a low time budget so that the segmentation may be performed relatively quickly, to facilitate continued imaging. As another example, after the scanning session is complete and a user (e.g., a physician) is taking measurements of anatomical features captured in images of the scanning session, the user may opt for an automatic measurement of a given feature to be performed, which may include segmenting the given feature to identify the exact borders of the given feature (from which the measurements may be taken). In such cases, the accuracy of the segmentation may be highly valued but the amount of time taken to perform the segmentation may not be highly valued (given that the imaging session is complete). Accordingly, the user may select a high time budget so that the segmentation may be performed with higher accuracy.

By including a time budget as a factor in how many iterations/instances of a deep learning model(s) are to be performed, and hence how quickly the final output is produced, the same deep learning system may be deployed for a variety of users and across various devices (e.g., a scanner and a server) with varying memory and processing power, with the deep learning system capable of generating an output at a variety of compute times to fulfill various demands. In doing so, the need for multiple different deep learning models (stored on the same device or on different devices) may be reduced, which may save memory. Further, by only devoting the processing resources needed for the generation of the output at the accuracy dictated by the user, the generation of higher accuracy output that demands larger processing resources may be avoided during circumstances where the higher accuracy output is not warranted, thereby improving the processing efficiency of the device executing the deep learning system.

Turning now to FIG. 4, it shows a flow chart illustrating an example method 400 for generating a final output from a deep learning system based on a time budget. Method 400 is described with regard to the systems and components of FIGS. 1-2, though it should be appreciated that the method 400 may be implemented with other systems and components without departing from the scope of the present disclosure. Method 400 may be carried out according to instructions stored in non-transitory memory of a computing device, such as memory 120 of FIG. 1 or memory 206 of FIG. 2, and executed by a processor of the computing device, such as processor 116 of FIG. 1 or processor 204 of FIG. 2.

At 402, method 400 includes obtaining a medical image and a time budget. The medical image may be an ultrasound image generated with the ultrasound imaging system 100 of FIG. 1, or another suitable medical image (e.g., CT image, MR image, etc.). The medical image may include one or more anatomical features of a subject (e.g., a patient) and may be determined to be suitable for input to the deep learning system in order to produce an output based on the medical image. The medical image may be a two-dimensional (2D) image or a three-dimensional (3D) image. Further, in some examples, the medical image may be a frame of a video. As a non-limiting example, a user (e.g., a clinician such as an operator of the ultrasound system) may provide an indication that a task performed by the deep learning system (e.g., segmentation) is to be performed on the medical image, such as by selecting a specific user interface element while the medical image is being displayed, or the system may automatically determine that the task is to be performed on the medical image (e.g., by identifying that the user has requested an automated measurement be performed on images of a particular scan plane and further determining that the medical image is in the given scan plane). As explained previously, the time budget may be a value or term that indicates a relative speed at which the task is to be performed by the deep learning system and hence the amount of time for the output of the deep learning system to be generated. In some examples, the time budget may be provided in the form of a prompt (e.g., by a user or exam protocol) and/or selected by a user via a suitable user input, such as via input to a menu, text box, or another suitable user interface element. In other examples, the time budget may be preset by the system based on a scan protocol the user is following while imaging the patient, the type of task being performed, the context of the task (e.g., if the task is being performed to facilitate an automated measurement), and/or other parameters. The time budget may be a value on a numerical scale, a number of seconds, a percentage, a relative degree of speed, or a relative degree of accuracy, as explained previously.

At 404, the medical image is entered as input to one or more deep learning models of the deep learning system. In some examples, the deep learning system may include one deep learning model, such as one neural network. In other examples, the deep learning system may include a plurality of deep learning models, such as a plurality of neural networks. In either example, the one or more deep learning models may all be trained to perform the same task, such as segmenting a particular anatomical feature (e.g., the kidney). When the deep learning system includes one deep learning model, the medical image may be entered as input to the deep learning model multiple times in order to perform multiple iterations of the deep learning model. When the deep learning system includes more than one deep learning model, the medical image may be input into one or more of the deep learning models one time or multiple times. The number of deep learning models that are deployed to generate output based on the medical image, or the number of iterations of the deep learning model that are performed in order to generate output, may be based on the time budget, as indicated at 406.

When the deep learning system includes a plurality of different deep learning models, the number of those deep learning models that are deployed to generate output based on the medical image may be selected based on the time budget, in a manner that more deep learning models are deployed when the time budget is higher relative to when the time budget is lower. As a non-limiting example, the deep learning system may include 20 deep learning models. When the time budget is “high,” all 20 deep learning models may be deployed. When the time budget is “medium,” 10 of the deep learning models may be deployed. When the time budget is “low,” 5 of the deep learning models may be deployed. The deep learning models that are deployed may be selected randomly, at least in some examples. It is to be appreciated that the number of deep learning models that are deployed may scale linearly or non-linearly with the time budget.

When the deep learning system includes one deep learning model, the number of model iterations performed to generate output based on the medical image may be based on the time budget. As a non-limiting example, MC dropout may be performed so that different neurons are dropped at each model iteration. When the time budget is “high,” 100 iterations of the deep learning model may be performed, with a different neuron (or combination of neurons) dropped for each iteration. When the time budget is “medium,” 50 iterations of the deep learning model may be performed, with a different neuron (or combination of neurons) dropped for each iteration. When the time budget is “low,” 10 iterations of the deep learning model may be performed, with a different neuron (or combination of neurons) dropped for each iteration. It is to be appreciated that the number of model iterations performed may scale linearly or non-linearly with the time budget. Further, the maximum number of model iterations performed (e.g., for a high time budget) may be different when MC dropout is performed relative to when test-time augmentation is performed.

When test-time augmentation is performed, the medical image may be transformed in a different manner (e.g., augmented) for each iteration that is performed. For example, a first iteration may include entering the medical image as input to the deep learning model without altering the medical image. A second iteration may include rotating the medical image clockwise by 15° and entering the rotated medical image as input to the deep learning model; a third iteration may include adjusting the brightness of the medical image by a specified amount and entering the adjusted-brightness image as input to the deep learning model. The medical image may be rotated, flipped, zoomed, sheared, shifted, and/or combinations thereof, and/or any other type of data augmentation may be performed to adjust the medical image. The augmentations may be randomly applied, though some augmentations may have constraints in order to maintain the integrity of features of interest in the medical image (e.g., horizontal flipping may be performed but not vertical or vice versa).

In some examples, the deep learning model may be a UniverSeg model that is trained to generate output based on an input medical image and a support set of images that provides context for the task being performed. For example, when the task is segmentation of a kidney in the medical image, support set may include two or more reference medical images that each include a kidney and corresponding label images that indicate the position, size, shape, etc., of the kidney. In such examples, the support set of images may change with each model iteration.

At 408, the outputs from the one or more deep learning models are received. As explained above, the number of models/model iterations deployed is based on the time budget, and hence the number of outputs that are received is also based on the time budget, as indicated at 410. In some examples, when the time budget is the minimum possible time budget, only one output may be received (e.g., the medical image may be entered as input to one deep learning model, one time). However, when the time budget is greater than the minimum time budget, or when the deep learning system is configured to deploy more than one model/iteration even at the minimum time budget, more than one output is received. Each output may represent or be usable to perform the task explained above. For example, when the task is segmenting the kidney, each output may be a segmentation mask that indicates, for each pixel or voxel of the medical image, whether that pixel or voxel is the kidney (e.g., a label of 1) or not (e.g., a label of 0). Alternatively, each output may be the segments of the medical image (e.g., the pixels or voxels) determined to be the kidney.

Thus, at 412, method 400 includes combining the received outputs to form a final output. In some examples, as indicated at 412, the received outputs may be combined according to a STAPLE algorithm. As explained previously, the STAPLE algorithm may estimate the true, hidden output based on the distribution of the received outputs. Combining the received outputs using the STAPLE algorithm may include combining all the received outputs into a test output, by simple voting on each pixel or voxel. The accuracy of each received output compared to this initial test output is then determined and used to re-draw a new, second test output by weighting the votes of the received outputs according to their accuracy. This process then repeats until the test output converges, at which point the converged test output is output as the final output. However, in other examples, the received outputs may be combined using averaging (e.g., non-weighted averaging) or another mechanism (e.g., voting), as indicated at 416.

At 418, the final output is displayed on a display device, applied in a downstream process, and/or saved in memory. For example, when the final output is a segmentation mask of the kidney, the final segmentation mask may be displayed on a display device, or the final segmentation mask may be usable to generate an image of only the kidney (e.g., by applying the segmentation mask to the medical image), highlight the kidney on the medical image (e.g., by changing the color, opacity, etc., of the pixels/voxels of the kidney in the medical image), perform measurements of the kidney (e.g., volume, width, etc.), or to perform other suitable downstream applications. Method 400 then ends.

FIG. 5 schematically shows an example process 500 for training a deep learning system based on a memory budget and FIG. 6 schematically shows an example process for producing a final output from an input using the deep learning system trained according to the process of FIG. 5. The process 600 may be implemented by image processing system 202 using the deep learning system 208 and inference module 209, at least in some examples. In some examples, the process 500 may also be implemented by image processing system 202 using the image data 210 and training module 212, though it is to be appreciated that in other examples, the process 500 may be carried out using image data 210 and training module 212 implemented on a different device (e.g., a server).

Referring to process 500, a training dataset 502 is used to train a plurality of shallow models 504. Each shallow model may be a deep learning model, such as a neural network. In some examples, each deep learning model may have a different architecture, while in other examples, each deep learning model may have the same architecture. In some examples, an entirety of the training dataset 502 may be used to train each model of the plurality of shallow models 504. In other examples, the training dataset 502 may be divided into training subsets and each subset may be used to train a respective shallow model. In still further examples, the plurality of shallow models may be instances of the same deep learning model, with each instance representing a perturbation to the deep learning model (e.g., adjustment of model weight, dropping of one or more neurons, etc.) or a perturbation of the image that is to be input during inference.

The training may be informed by a memory budget 503 (denoted M in FIG. 5). The memory budget 503 may constrain the training so that the number of shallow models included in the plurality of shallow models 504 that are ultimately deployed after training is based on the memory budget. For example, a higher number of shallow models may demand more memory be devoted to the plurality of shallow models and thus the higher the memory budget, the higher the number of shallow models that may be included in the plurality of shallow models. The memory demanded by the plurality of shallow models may include the memory needed to store the plurality of shallow models and the instructions for executing the plurality of shallow models. Thus, during training, the total memory needed to store and execute the plurality of shallow models 504 may be determined. If the total memory exceeds the memory budget, one or more shallow models may be dropped from the plurality of shallow models until the total memory equals or is below the memory budget. When the training includes the training of one deep learning model that is to be iterated multiple times using MC drop out or test-time augmentation, for example, a first total memory needed to store and execute the deep learning model one time may be determined (with an unaugmented image and with all neurons active), a second total memory needed to store and execute the deep learning model an additional one time (e.g., in addition to the total memory for storing and executing the model one time) may be determined (with an augmented image or with one or more neurons dropped), a third total memory needed to store and execute the deep learning a second additional time may be determined, etc., until the maximum number of iterations the deep learning model can perform without exceeding the memory budget is identified. After training, the plurality of shallow models 504 may be configured to be executed as part of a deep learning system to perform a desired task (e.g., image segmentation) without surpassing the memory budget.

Process 600 may include identification/reception of an input image 602 to be entered as input to a deep learning system to generate an output. The input image 602 may be a medical image, such as an ultrasound image of a patient generated with the ultrasound imaging system 100 of FIG. 1.

The deep learning system may include one or more deep learning models that may be iterated one or more times to produce a plurality of outputs. The number of models applied to produce the plurality of outputs, or the number of times a model is iterated to produce the plurality of outputs, may be determined during training based on a memory budget, as explained above with respect to FIG. 5. For example, the deep learning model(s) included in the deep learning system may be the plurality of shallow models 504 trained according to process 500. As shown in FIG. 6, the input image 602 (denoted X in FIG. 6) may be input to a plurality of model instances 604, represented in FIG. 6 as θ₁, θ₂, θ₃, and on up to θ_{N(M)} where the number of model instances in the plurality of model instances 604 is a function of the memory budget (M).

As explained above with respect to FIG. 3, in some examples, the plurality of model instances 604 may include a plurality of different models, such that θ₁ represents a first deep learning model, θ₂ represents a second deep learning model, θ₃ represents a third deep learning model, etc. In such an example, the different deep learning models may be models with the same architecture (e.g., convolutional neural networks (CNNs) with UNet architecture) but trained with different training datasets; models with different architectures (e.g., a fully convolutional network, an autoencoder network, a UNet, etc.) trained with the same training dataset; or a combination of both.

In other examples, the plurality of model instances 604 may include different iterations of the same deep learning model, such that θ₁ represents a first iteration of the deep learning model, θ₂ represents a second iteration of the deep learning model, θ₃ represents a third iteration of the deep learning model, etc. In such an example, each iteration may be different in some regard that results in a different output. For example, when test-time augmentation is applied, the input image 602 may be augmented in a different manner at each iteration, as explained previously. As another example, when MC dropout is applied, the same (unaugmented) input image 602 may be entered as input for each model instance, and one or more neurons of the deep learning model may be dropped each iteration, such that θ₁ may represent a first iteration of the deep learning model where a first neuron of the deep learning model is dropped, θ₂ may represent a second iteration of the deep learning model where a second neuron is dropped, θ₃ may represent a third iteration of the deep learning model where a third neuron is dropped, etc. Still other modifications of the input image and/or model may be performed at each iteration to result in the plurality of model instances 604, such as changing the weights of the deep learning model each iteration, changing the support set images entered along with the input image (when the deep learning model is a UniverSeg model) each iteration, etc.

Once the input image 602 has been entered into the deep learning model(s) for the plurality of model instances 604, a plurality of outputs 606 is generated. Each instance/iteration of the deep learning model(s) may generate a respective output, such as Y₁ generated by instance θ₁, Y₂ generated by instance θ₂, Y₃ generated by instance θ₃, and on up to Y_{N} generated by instance θ_{N(M)}. Each output of the plurality of outputs 606 may be similar but not identical. The plurality of outputs 606 may therefore be combined at 608 to form a final output 610 (denoted Y in FIG. 6). In the example shown in FIG. 6, the outputs may be combined using the STAPLE algorithm, as explained above, which may estimate the true, hidden output based on the distribution of the outputs of the plurality of outputs 606. In some examples, other mechanisms may be applied to combine the outputs, such as a non-weighted averaging of the outputs.

Thus, the process 600 may be applied with a deep learning system to generate an output Y (e.g., a segmentation mask) based on an input X (e.g., an image) without exceeding a predetermined memory budget that is set (e.g., by a user) during training of the deep learning system. In doing so, the output may be generated within the memory budget, which may vary based on the device implementing the deep learning system or the specific task being performed. For example, during a scanning session where a patient is being actively imaged with an imaging system (e.g., the ultrasound imaging system 100 of FIG. 1), an operator of the imaging system may desire to view an identification of a particular anatomical feature in a selected image of the patient in order to determine if further images should be acquired or to ensure that the particular anatomical feature is actually being imaged (which may be particularly helpful for novice operators). In such circumstances, the accuracy of the segmentation performed on the selected image to identify the anatomical feature may not be valued as highly as other circumstances, and the memory available on the medical imaging system may be limited. In this case, the deep learning system may include a relatively small number of deep learning models or be configured to execute a relatively small number of iterations of the deep learning model, so that the segmentation may be performed by the medical imaging system, to facilitate continued imaging. As another example, after the scanning session is complete and a user (e.g., a physician) is taking measurements of anatomical features captured in images of the scanning session, the user may opt for an automatic measurement of a given feature to be performed, which may include segmenting the given feature to identify the exact borders of the given feature (from which the measurements may be taken). In such cases, the accuracy of the segmentation may be highly valued and the memory available on the device executing the deep learning system may be relatively high (e.g., the deep learning system may be executed on a server or the cloud). Accordingly, the deep learning system may include a relatively large number of deep learning models or be configured to execute a relatively large number of iterations of the deep learning model so that the segmentation may be performed with higher accuracy.

By including a memory budget as a factor in how many iterations/instances of a deep learning model(s) are to be performed, and hence how quickly and accurately the final output is produced, different deep learning systems may be deployed across various devices (e.g., a scanner and a server) with varying memory and processing power, with each deep learning system capable of generating an output at demanded/available memory budget. In doing so, the memory footprint of the deep learning system may be tailored to the specific availability of the device implementing the deep learning system and/or to the accuracy demands of the task being performed, which may save memory in situations where less accuracy is demanded.

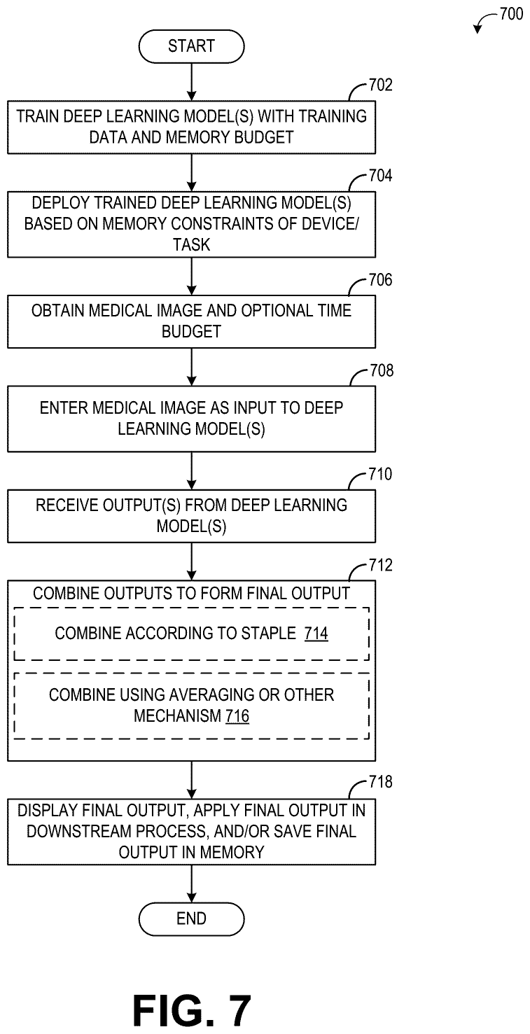

FIG. 7 shows a flow chart illustrating an example method 700 for training and deploying a deep learning system based on a memory budget. Method 700 is described with regard to the systems and components of FIGS. 1-2, though it should be appreciated that the method 700 may be implemented with other systems and components without departing from the scope of the present disclosure. Method 700 may be carried out according to instructions stored in non-transitory memory of a computing device, such as memory 120 of FIG. 1 or memory 206 of FIG. 2, and executed by a processor of the computing device, such as processor 116 of FIG. 1 or processor 204 of FIG. 2.

At 702, method 700 may include training one or more deep learning models with a training dataset and based on a memory budget. The training may be performed as described above with respect to process 500. Briefly, the training may include applying a desired training regime (e.g., supervised learning) to one or more deep learning models (e.g., neural networks) using the training data, which may include medical images and corresponding ground truth (e.g., segmentation masks when the deep learning model(s) are trained to perform image segmentation). The memory budget may be set by a user based on the memory constraints of the device(s) that will ultimately execute the trained deep learning model(s) and/or based on the demanded accuracy of the output that is to be generated by the trained deep learning model(s).

At 704, the trained deep learning model(s) are deployed on one or more devices (e.g., image processing system 202) based on the memory constraints of the device(s) and/or task to be performed. For example, different versions of the deep learning model(s) may be generated during training, such as a first version trained with a higher memory budget and a second version trained with a lower memory budget. The first version may be deployed on device(s) with higher available memory and/or for tasks that demand higher accuracy while the second version may be deployed on device(s) with lower available memory and/or for tasks that demand lower accuracy. It is to be appreciated that the training of the deep learning model(s) may take place on a different device than the device(s) that the trained deep learning model(s) are ultimately deployed.

At 706, a medical image is obtained and optionally a time budget. The medical image may be an ultrasound image generated with the ultrasound imaging system 100 of FIG. 1, or another suitable medical image (e.g., CT image, MR image, etc.). The medical image may include one or more anatomical features of a subject (e.g., a patient) and may be determined to be suitable for input to the deep learning system in order to produce an output based on the medical image. As a non-limiting example, a user (e.g., a clinician such as an operator of the ultrasound system) may provide an indication that a task performed by the deep learning system (e.g., segmentation) is to be performed on the medical image, such as by selecting a specific user interface element while the medical image is being displayed, or the system may automatically determine that the task is to be performed on the medical image (e.g., by identifying that the user has requested an automated measurement be performed on images of a particular scan plane and further determining that the medical image is in the given scan plane). The time budget may be specified as explained above with respect to FIG. 4.

At 708, the medical image is entered as input to one or more deep learning models of the deep learning system. In some examples, the deep learning system may include one deep learning model, such as one neural network. In other examples, the deep learning system may include a plurality of deep learning models, such as a plurality of neural networks. In either example, the one or more deep learning models may all be trained to perform the same task, such as segmenting a particular anatomical feature (e.g., the kidney). When the deep learning system includes one deep learning model, the medical image may be entered as input to the deep learning model multiple times in order to perform multiple iterations of the deep learning model. When the deep learning system includes more than one deep learning model, the medical image may be input into one or more of the deep learning models one time or multiple times. The number of deep learning models that are deployed to generate output based on the medical image, or the number of iterations of the deep learning model that are performed in order to generate output, may be based on the memory budget as defined during training, as explained above, and further based on the time budget (when obtained). When the deep learning system includes one deep learning model, the different model iterations may be performed using MC dropout, test-time augmentation, or different support sets of images, similar to the method 400 explained above with respect to FIG. 4.

At 710, the outputs from the one or more deep learning models are received. As explained above, the number of models/model iterations deployed is based on the preset memory budget and optionally the time budget, and hence the number of outputs that are received is also based on the memory budget and optionally the time budget. In some examples, when the memory budget is the minimum possible memory budget, only one output may be received (e.g., the medical image may be entered as input to one deep learning model, one time). However, when the memory budget is greater than the minimum, or when the deep learning system is configured to deploy more than one model/iteration even at the minimum memory budget, more than one output is received. Each output may represent or be usable to perform the task explained above. For example, when the task is segmenting the kidney, each output may be a segmentation mask that indicates, for each pixel or voxel of the medical image, whether that pixel or voxel is the kidney (e.g., a label of 1) or not (e.g., a label of 0). Alternatively, each output may be the segments of the medical image (e.g., the pixels or voxels) determined to be the kidney.

Thus, at 712, method 700 includes combining the received outputs to form a final output. In some examples, as indicated at 714, the received outputs may be combined according to a STAPLE algorithm. As explained previously, the STAPLE algorithm may estimate the true, hidden output based on the distribution of the received outputs. Combining the received outputs using the STAPLE algorithm may include combining all the received outputs into a test output, by simple voting on each pixel or voxel. The accuracy of each received output compared to this initial test output is then determined and used to re-draw a new, second test output by weighting the votes of the received outputs according to their accuracy. This process then repeats until the test output converges, at which point the converged test output is output as the final output. However, in other examples, the received outputs may be combined using averaging (e.g., non-weighted averaging) or another mechanism (e.g., voting), as indicated at 716.

At 718, the final output is displayed on a display device, applied in a downstream process, and/or saved in memory. For example, when the final output is a segmentation mask of the kidney, the final segmentation mask may be displayed on a display device, or the final segmentation mask may be usable to generate an image of only the kidney (e.g., by applying the segmentation mask to the medical image), highlight the kidney on the medical image (e.g., by changing the color, opacity, etc., of the pixels/voxels of the kidney in the medical image), perform measurements of the kidney (e.g., volume, width, etc.), or perform other suitable downstream applications. Method 700 then ends.

In some examples, the embodiments disclosed above may be combined so that a deep learning system trained based on a memory budget is also configured to select the number of models/model iterations based on a time budget specified by a user during inference. For example, the deep learning system may be configured during training based on a memory budget, as explained above with respect to process 500. The number of deep learning models in the deep learning system, or the number of model iterations the deep learning system is configured to perform, may represent a total possible number of models/model iterations available. Then, during inference, a user may set a time budget, as explained above with respect to FIGS. 3 and 4. If the time budget is lower than a maximum time budget, the number of models, or the number of model iterations, deployed by the deep learning system to generate the plurality of outputs may be reduced relative to the total possible number, as a function of the time budget. In this way, processing efficiency and memory demands may be improved by ensuring, via the memory budget, that the memory demand of the deep learning system stays under an available/desired amount, even if a relatively high time budget is selected, and further by only executing the number of models or model iterations needed to meet the time budget.

In some examples, the memory budget may be informed by an expected range of time budgets that may be selected during inference. As explained previously, some devices or implementations may be expected to demand lower time budgets in order to produce model output results (e.g., segmentations) relatively quickly. When a deep learning system is trained based on a memory budget, if the expected time budget range is known in advance, the memory budget may be selected based on the expected time budget range. In the example that a relatively low time budget range is expected, the memory budget may be lower to avoid training and storing excess models that will likely go unused, for example. In the example that a relatively high time budget range is expected (e.g., for performing tasks where accuracy is a priority), the memory budget may be higher to provide sufficient models or model iterations to meet the expected high time budgets.

FIGS. 8 and 9 show example output that may be generated using a deep learning system as disclosed herein. FIG. 8 shows a first set of images 800 that includes a medical image 802 that may be entered as input to a deep learning system trained to output a segmentation mask of a kidney. The deep learning system may be configured to generate multiple outputs from the medical image 802 using MC dropout with 100 iterations of a deep learning model (e.g., a neural network), as explained above with respect to FIGS. 2-4, for example. Image 804 is a ground truth segmentation mask, which may be generated by an expert. Image 806 is a final segmentation generated by combining the multiple outputs (e.g., the 100 outputs produced by iterating the deep learning model 100 times) using averaging. Image 808 is a final segmentation generated by combining the multiple outputs using the STAPLE algorithm.

The similarity between the final segmentation shown in image 806 and the ground truth segmentation shown in image 804, as well as the similarity between the final segmentation shown in image 808 and the ground truth segmentation shown in image 804, was calculated using the Dice similarity coefficient. The Dice similarity coefficient was determined to be 0.813 for the final segmentation formed via averaging while the Dice similarity coefficient was determined to 0.899 for the final segmentation formed via the STAPLE algorithm. Further, the final segmentation shown in image 806 includes pixels spaced apart from the main segmentation, which may be the result of one or more outlier outputs from the multiple outputs that are maintained when the outputs are combined via averaging but are discarded when the multiple outputs are combined via the STAPLE algorithm. Thus, combining the outputs via the STAPLE algorithm may increase the accuracy of the final output relative to combining the outputs via averaging, although averaging may still produce sufficient accuracy for some or most applications.

Similarly, FIG. 9 shows a second set of images 900 that includes a medical image 902 that may be entered as input to a deep learning system trained to output a segmentation mask of a kidney. The deep learning system may be configured to generate multiple outputs from the medical image 902 using MC dropout with 100 iterations of a deep learning model (e.g., a neural network), as explained above with respect to FIGS. 2-4, for example. Image 904 is a ground truth segmentation mask, which may be generated by an expert. Image 906 is a final segmentation generated by combining the multiple outputs (e.g., the 100 outputs produced by iterating the deep learning model 100 times) using averaging. Image 908 is a final segmentation generated by combining the multiple outputs using the STAPLE algorithm.

The similarity between the final segmentation shown in image 906 and the ground truth segmentation shown in image 904, as well as the similarity between the final segmentation shown in image 908 and the ground truth segmentation shown in image 904, was calculated using the Dice similarity coefficient. The Dice similarity coefficient was determined to be 0.863 for the final segmentation formed via averaging while the Dice similarity coefficient was determined to 0.915 for the final segmentation formed via the STAPLE algorithm. Further, the final segmentation shown in image 906 includes pixels spaced apart from the main segmentation, which may be the result of one or more outlier outputs from the multiple outputs that are maintained when the outputs are combined via averaging but are discarded when the multiple outputs are combined via the STAPLE algorithm. Thus, combining the outputs via the STAPLE algorithm may increase the accuracy of the final output relative to combining the outputs via averaging, although averaging may still produce sufficient accuracy for some or most applications.

The deep learning system used to generate the outputs as shown in FIGS. 8 and 9 (e.g., a segmentation model for kidney segmentation on ultrasound B-mode images) also demonstrates that increasing the number of models/model iterations increases the accuracy of the output, and that combining the multiple outputs via the STAPLE algorithm improves accuracy relative to averaging, as shown in Table 1 below.

TABLE 1

| | Dice Coefficient | | | |
|---|---|---|---|---|
| Method | 1 iteration | 10 iterations | 50 iterations | 100 iterations |
| Average | 0.80 ± 0.11 | 0.83 ± 0.12 | 0.84 ± 0.12 | 0.83 ± 0.12 |
| STAPLE | 0.88 ± 0.03 | 0.88 ± 0.03 | 0.89 ± 0.02 | 0.89 ± 0.02 |

User preference has increasingly emerged as an important learning factor in deep learning architecture design. Performance and inference time are usually inversely correlated and the customizable deep learning system disclosed herein allows the user to control the trade-off through the input of a time budget. The customizable deep learning system disclosed herein provisions for the user to provide the time budget, which is utilized to provide a prediction in the user input time, wherein the higher the time budget, the higher is the chance of a prediction with higher accuracy. For an operator of medical devices, the customizable deep learning system provides personalization to operate the algorithm in different speed modes while being cognizant of the implications on accuracy.

A conventional deep learning model can be expressed as: f:X→Y. In a segmentation problem, X is in the input image and Y is the segmentation mask. The training of the deep learning system disclosed herein does not differ from conventional training and is architecture/training regime agnostic. During inference, a time-budget informed model, takes as input an additional parameter time budget T:g:(X, T)→Y. The output, and consequently the performance, depends on the time budget, which is a user input. In this way, multiple outputs are generated for a given input, which may be realized with number of methods like MC-Dropout, Test Time Augmentation etc. to produce a multiplicity of outputs {yᵢ}^{i=M} for a given input Xᵢ, where the multiplicity factor is determined by T, a user input. A choice of methods is available in combining the multiplicity of masks, like simple average/voting, although the use of STAPLE to combine the different segmentation masks produced in the first stage, as disclosed herein, further improves the accuracy.

A technical effect of receiving a plurality of outputs from a deep learning system based on an input and a time budget set by a user during inference and combining the plurality of outputs to form a final output is that the final output may be generated in a time frame specified by a user and without performing expensive operations when not demanded by the user, which may increase processing efficiency. Another technical effect of receiving a plurality of outputs from a deep learning system based on an input and a memory budget set during training of the deep learning system and combining the plurality of outputs to form a final output is that the deep learning system may have a maximum memory footprint that can be tailored to a specific device executing the deep learning system, which may improve the efficiency of the specific device.

The disclosure also provides support for a system, comprising: a processor, and non-transitory memory storing instructions executable by the processor to: receive a user selection of a time budget, enter an input to a deep learning system, the deep learning system including one or more deep learning models configured to generate a plurality of outputs based on the input, and wherein a number of outputs included in the plurality of outputs is based on the time budget, combine the plurality of outputs to form a final output, and output the final output for display on a display device, for downstream processing, and/or for storage in memory. In a first example of the system, the deep learning system is configured to perform multiple iterations with a deep learning model of the one or more deep learning models, each iteration including entering the input to the deep learning model and receiving a respective output from the deep learning model, wherein a number of iterations performed is selected based on the time budget. In a second example of the system, optionally including the first example, the deep learning model is perturbed each iteration and/or the input is augmented each iteration such that a different output is generated each iteration. In a third example of the system, optionally including one or both of the first and second examples, combining the plurality of outputs to form the final output comprises combining the plurality of outputs using non-weighted averaging, voting, or a STAPLE algorithm. In a fourth example of the system, optionally including one or more or each of the first through third examples, the deep learning system includes a plurality of deep learning models, wherein one or more deep learning models of the plurality of deep learning models are selected based on the time budget, and wherein the input is entered to only the selected one or more deep learning models. In a fifth example of the system, optionally including one or more or each of the first through fourth examples, a number of deep learning models included in the plurality of deep learning models is based on a memory budget set by a user during training of the plurality of deep learning models of the deep learning system. In a sixth example of the system, optionally including one or more or each of the first through fifth examples, the input is a medical image, a non-medical image, a block of text, or raw image data.

The disclosure also provides support for a method, comprising: receiving a plurality of outputs from a deep learning system based on an input image and a time budget set by a user during inference, combining the plurality of outputs to form a final output, and outputting the final output for display on a display device, for downstream processing, and/or for storage in memory. In a first example of the method, the input image comprises a medical image and each output of the plurality of outputs is a segmentation mask of an anatomical feature. In a second example of the method, optionally including the first example, receiving the plurality of outputs from the deep learning system based on the input image and the time budget set by the user during inference comprises performing multiple iterations with a deep learning model of the deep learning system, each iteration including entering the input image to the deep learning model and receiving a respective output from the deep learning model, wherein a number of iterations performed is selected based on the time budget. In a third example of the method, optionally including one or both of the first and second examples, the deep learning model is perturbed each iteration and/or the input image is augmented each iteration such that a different output is generated each iteration. In a fourth example of the method, optionally including one or more or each of the first through third examples, receiving the plurality of outputs from the deep learning system based on the input image and the time budget set by the user during inference comprises entering the input image to each of a plurality of deep learning models of the deep learning system and receiving a respective output from each of the plurality of deep learning models, wherein a number of deep learning models included in the plurality of deep learning models is selected based on the time budget. In a fifth example of the method, optionally including one or more or each of the first through fourth examples, each deep learning model of the plurality of deep learning models has a different architecture and/or is trained with a different training dataset, such that each deep learning model generates a different output. In a sixth example of the method, optionally including one or more or each of the first through fifth examples, combining the plurality of outputs to form the final output comprises combining the plurality of outputs using a STAPLE algorithm. In a seventh example of the method, optionally including one or more or each of the first through sixth examples, combining the plurality of outputs to form the final output comprises combining the plurality of outputs using voting or non-weighted averaging.

The disclosure also provides support for a method, comprising: receiving a plurality of outputs from a deep learning system based on an input image, a number of outputs included in the plurality of outputs based on a memory budget set by a user during training of one or more deep learning models of the deep learning system, combining the plurality of outputs to form a final output, and outputting the final output for display on a display device, for downstream processing, and/or for storage in memory. In a first example of the method, the deep learning system includes a plurality of deep learning models, each deep learning model configured to generate a respective output of the plurality of outputs, and wherein a number of deep learning models included in the plurality of deep learning models is based on the memory budget. In a second example of the method, optionally including the first example, the deep learning system includes a deep learning model configured to generate a respective output of the plurality of outputs each iteration of the deep learning model, and wherein a number of iterations of the deep learning model performed is based on the memory budget. In a third example of the method, optionally including one or both of the first and second examples, the deep learning model is perturbed each iteration and/or the input image is augmented each iteration such that a different output is generated each iteration. In a fourth example of the method, optionally including one or more or each of the first through third examples, combining the plurality of outputs to form the final output comprises combining the plurality of outputs using non-weighted averaging, voting, or a STAPLE algorithm. In a fifth example of the method, optionally including one or more or each of the first through fourth examples, the input image comprises a medical image and each output of the plurality of outputs is a segmentation mask of an anatomical feature.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A system, comprising:
a processor; and
non-transitory memory storing instructions executable by the processor to:
receive a user selection of a time budget;
enter an input to a deep learning system, the deep learning system including one or more deep learning models configured to generate a plurality of outputs based on the input, and wherein a number of outputs included in the plurality of outputs is based on the time budget;
combine the plurality of outputs to form a final output; and
output the final output for display on a display device, for downstream processing, and/or for storage in memory.

2. The system of claim 1, wherein the deep learning system is configured to perform multiple iterations with a deep learning model of the one or more deep learning models, each iteration including entering the input to the deep learning model and receiving a respective output from the deep learning model, wherein a number of iterations performed is selected based on the time budget.

3. The system of claim 2, wherein the deep learning model is perturbed each iteration and/or the input is augmented each iteration such that a different output is generated each iteration.

4. The system of claim 1, wherein combining the plurality of outputs to form the final output comprises combining the plurality of outputs using non-weighted averaging, voting, or a STAPLE algorithm.

5. The system of claim 1, wherein the deep learning system includes a plurality of deep learning models, wherein one or more deep learning models of the plurality of deep learning models are selected based on the time budget, and wherein the input is entered to only the selected one or more deep learning models.

6. The system of claim 5, wherein a number of deep learning models included in the plurality of deep learning models is based on a memory budget set by a user during training of the plurality of deep learning models of the deep learning system.

7. A method, comprising:
receiving a plurality of outputs from a deep learning system based on an input image and a time budget set by a user during inference;
combining the plurality of outputs to form a final output; and
outputting the final output for display on a display device, for downstream processing, and/or for storage in memory.

8. The method of claim 7, wherein the input image comprises a medical image and each output of the plurality of outputs is a segmentation mask of an anatomical feature.

9. The method of claim 7, wherein receiving the plurality of outputs from the deep learning system based on the input image and the time budget set by the user during inference comprises performing multiple iterations with a deep learning model of the deep learning system, each iteration including entering the input image to the deep learning model and receiving a respective output from the deep learning model, wherein a number of iterations performed is selected based on the time budget.

10. The method of claim 9, wherein the deep learning model is perturbed each iteration and/or the input image is augmented each iteration such that a different output is generated each iteration.

11. The method of claim 7, wherein receiving the plurality of outputs from the deep learning system based on the input image and the time budget set by the user during inference comprises entering the input image to each of a plurality of deep learning models of the deep learning system and receiving a respective output from each of the plurality of deep learning models, wherein a number of deep learning models included in the plurality of deep learning models is selected based on the time budget.

12. The method of claim 11, wherein each deep learning model of the plurality of deep learning models has a different architecture and/or is trained with a different training dataset, such that each deep learning model generates a different output.

13. The method of claim 7, wherein combining the plurality of outputs to form the final output comprises combining the plurality of outputs using a STAPLE algorithm.

14. The method of claim 7, wherein combining the plurality of outputs to form the final output comprises combining the plurality of outputs using voting or non-weighted averaging.

15. A method, comprising:
receiving a plurality of outputs from a deep learning system based on an input image, a number of outputs included in the plurality of outputs based on a memory budget set by a user during training of one or more deep learning models of the deep learning system;
combining the plurality of outputs to form a final output; and
outputting the final output for display on a display device, for downstream processing, and/or for storage in memory.

16. The method of claim 15, wherein the deep learning system includes a plurality of deep learning models, each deep learning model configured to generate a respective output of the plurality of outputs, and wherein a number of deep learning models included in the plurality of deep learning models is based on the memory budget.

17. The method of claim 15, wherein the deep learning system includes a deep learning model configured to generate a respective output of the plurality of outputs each iteration of the deep learning model, and wherein a number of iterations of the deep learning model performed is based on the memory budget.

18. The method of claim 17, wherein the deep learning model is perturbed each iteration and/or the input image is augmented each iteration such that a different output is generated each iteration.

19. The method of claim 15, wherein combining the plurality of outputs to form the final output comprises combining the plurality of outputs using non-weighted averaging, voting, or a STAPLE algorithm.

20. The method of claim 15, wherein the input image comprises a medical image and each output of the plurality of outputs is a segmentation mask of an anatomical feature.
